(19) United States
(12) Patent Application Publication
(10) Pub. No.: US 2013/0315557 A1
(43) Pub. Date: Nov. 28, 2013

(54) DEVICE AND METHOD FOR TESTING DISC PLAYER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: BING ZHOU, Shenzhen (CN); JUN LIU, Shenzhen (CN); NA LIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/900,610

(22) Filed: May 23, 2013

(30) Foreign Application Priority Data
May 28, 2012 (CN) 2012101682598

(51) Int. Cl. H04N 17/02

(52) U.S. Cl. CPC H04N 17/02
USPC 386/230

(57) ABSTRACT

A test method tests read performance of a disc player. In the test method, a test optical disc stores data that is capable of being reproduced into a plurality of images each with a different single primary color. A storage unit stores the plurality of single primary colors. The disc player reads the test optical disc to generate video signals. Test images are displayed according to the video signals. The color of the test images are continuously detected and determining whether the currently detected color is the same as one of the single primary colors stored in the storage unit. And determining that the read performance of the disc player is not satisfactory if the currently detected color is not the same as one of the single primary colors stored in the storage unit.

### BACKGROUND

1. Technical Field

The disclosed embodiments relate to test devices and, particularly, to a device and a method for testing read performance of disc players.

2. Description of Related Art

A method for testing read performance of a disc player is that an operator observes data displayed on a display screen that is reproduced from an optical disc played by the disc player. If the display screen fails to display images, the operator may determine that the read performance of the disc player is unsatisfactory. This test method needs to be continuously monitored by the operator, and thus, over an extended period of time, is susceptible to operator's misjudgments.

Therefore, there is room for improvement in the art.

### BRIEF DESCRIPTION OF THE DRAWINGS

Many aspects of the embodiments can be better understood with reference to the drawing. The components in the drawing are not necessarily drawn to scale, the emphasis instead being placed upon clearly illustrating the principles of the present embodiments. Moreover, in the drawings, like reference numerals designate corresponding parts throughout two views.

FIG. 1 is a block diagram showing a test device in accordance with one embodiment.

FIG. 2 is a flow chart showing a test method in accordance with one embodiment.

### DETAILED DESCRIPTION

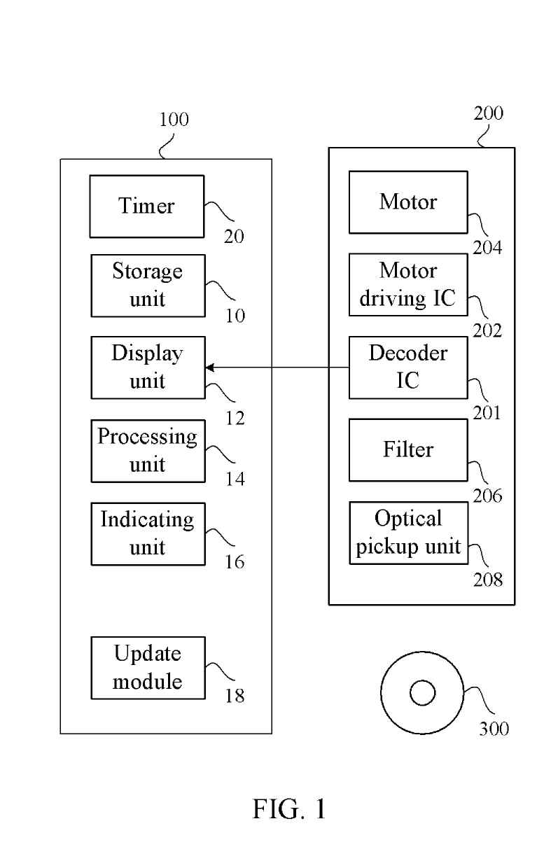

Referring to the FIG. 1, a test device 100 in accordance with one embodiment is illustrated. The test device 100 tests read performance of a disc player 200. The disc player 200 reads a test optical disc 300 to generate video signals. The test optical disc 300 stores data that is capable of being reproduced into a plurality of images each with different single primary color, for example white, red, blue, green, and black primary colors. Each image with the single primary color has a same predetermined display period, for example 2 seconds.

The test device 100 includes a storage unit 10, a display unit 12, and a processing unit 14. The storage unit 10 stores the plurality of single primary colors and the predetermined display period. The display unit 12 receives the video signals from the disc player 200 and displays test images according to the video signals.

The processing unit 14 continuously detects the color of the test images, determines whether the currently detected color is the same as one of the single primary colors stored in the storage unit 10. In detail, the processing unit 14 calculates an average R-value, an average G-value, and an average B-value of the pixels in the display unit 12 to acquire the color of the test images. RGB-red, green and blue are the primary colors.

If the currently detected color is not the same as one of the single primary colors, the processing unit 14 determines that the read performance of the disc player 200 is not satisfactory.

If the currently detected color is the same as one of the single primary colors, the processing unit 14 detects a duration of the currently detected color. The processing unit 14 also determines that the read performance of the disc player 200 is not satisfactory if the duration is not equal to the predetermined display period.

The processing unit 14 further determines that the read performance of the disc player 200 is satisfactory if all detected colors substantially match all single primary colors stored in the storage unit 10 and if the duration of each single detected color is equal to the predetermined display period.

Furthermore, the test device 100 further includes an indicating unit 16 and an update module 18. The processing unit 14 controls the indicating unit 16 to output an indication of abnormal read performance including reasons for the abnormalities and possible solutions. The update module 18 is connected to the Internet for updating the reasons for abnormalities and possible solutions.

The disc player 200 includes a motor driving IC 202, a motor 204, a decoder IC 201, an optical pickup unit 208, and a filter 206 connected between the decoder IC and the optical pickup unit 208; the motor driving IC 202 transmits a drive signal to the motor 204, the motor 204 spins the test optical disc 300 according to the drive signal. The decoder IC 201 transmits a control signal to the optical pickup unit 208 through the filter 206, the optical pickup unit 208 reads the test optical disc 300 in response to the control signal; the filter 206 filters the control signal. In this embodiment, the decoder IC is an MPEG decoder IC. In detail, the reasons for the abnormalities and the solutions comprises malfunctions of the optical pickup unit 208 and the solutions of repairing or replacing the optical pickup unit 208; malfunctions of the filter 206 and the solutions of repairing or replacing the filter 206; malfunctions of the motor driving IC 202 and the solutions of repairing or replacing the motor driving IC 202; malfunctions of the decoder IC 201 and the solutions of repairing or replacing the decoder IC 201; damages to the optical pickup unit 208 by electrostatic discharge (ESD) and the solutions of replacing the damaged optical pickup unit 208.

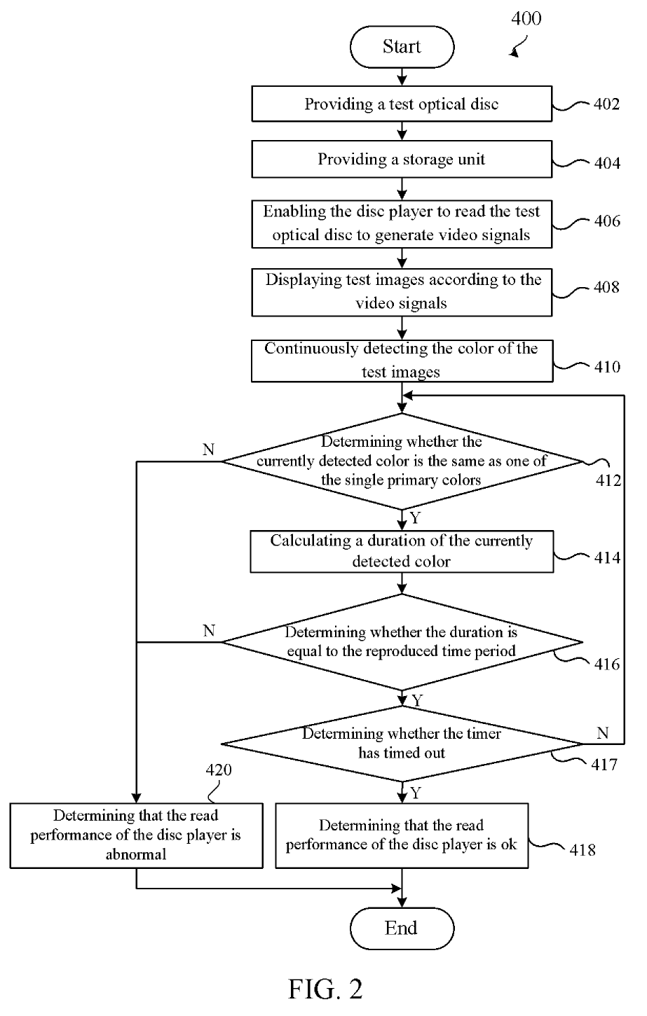

Referring to FIG. 2, a test method 400 in accordance with one embodiment is illustrated. The test method 400 is used for testing read performance of the disc player 200. The test method 400 is performed by the test device 100. The test device 100 further includes a timer 20 that counts a predetermined time period from a point in time when the disc player 200 begins to read the test optical disc 300. The test method 400 includes the following steps.

Step 402: the test optical disc 300 stores data that is capable of being reproduced into a plurality of images each with a different single primary color, for example white, red, blue, green, and black.

Step 404: the storage unit 10 stores the plurality of single primary colors.

Step 406: the disc player 200 reads the test optical disc 300 to generate video signals.

Step 408: the display unit 12 receives the video signals from the disc player 200 and displays test images according to the video signals.

Step 410: the processing unit 14 continuously detects the color of the test images. In detail, the processing unit 14 calculates an average R-value, an average G-value, and an average B-value of the pixels in the display unit 12 to acquire the color of the test images.

Step 412: the processing unit 14 determines whether a currently detected color is the same as one of the single primary colors stored in the storage unit 10. If the currently detected color is the same as one of the single primary colors stored in the storage unit 10, the process goes to the step 414; if not, the process goes to the step 420.

Step 414: the processing unit 14 calculates a duration of the currently detected color if the currently detected color is the same as one of the single primary colors.

Step 416: the processing unit 14 determines whether the duration is equal to the predetermined display period. If the duration is equal to the predetermined display period, the process goes to the step 417. If not, the process goes to the step 420.

Step 417: the processing unit 14 determines whether the timer 20 has timed out because the timed period has expired; if the timer 20 has timed out, the process goes to the step 418; if not, the process goes to the step 412.

Step 418: the processing unit 14 determines that the read performance of the disc player 200 is satisfactory. That is, all detected colors are respectively and substantially the same as all single primary colors stored in the storage unit 10 and the duration of each single detected color is equal to the predetermined display period.

Step 420: the processing unit 14 determines that the read performance of the disc player 200 is not satisfactory.

Furthermore, the processing unit 14 controls the indicating unit 16 to output an indication of abnormality including reasons for the abnormality and possible solutions. The update module 18 is connected to the Internet for updating the reasons for the abnormalities and possible solutions.

As described above, the reasons for the abnormalities and the possible solutions includes malfunctions of the optical pickup unit 208 and the solutions of repairing or replacing the optical pickup unit 208; malfunctions of the filter 206 and the solutions of repairing or replacing the filter 206; malfunctions of the motor driving IC 202 and the solutions of repairing or replacing the motor driving IC 202; malfunctions of the decoder IC 201 and the solutions of repairing or replacing the decoder IC 201, damages to the optical pickup unit 208 by ESD and the solutions of replacing the damaged optical pickup unit 208.

The test device 100 and the test method 400 can carry out a test of the read performance of the disc player 200 automatically, which provides greater convenience for users.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. A test device for testing read performance of a disc player, the disc player reading a test optical disc to generate video signals, the test optical disc storing data that is capable of being reproduced into a plurality of images each with different single primary color, the test device comprising:
a storage unit that stores the plurality of single primary colors;
a display unit for receiving the video signals from the disc player and displaying test images according to the video signals; and
a processing unit for continuously detecting the color of the test images, determining whether the currently detected color is the same as one of the single primary colors stored in the storage unit;
wherein the processing unit determines that the read performance of the disc player is not satisfactory if the currently detected color is not the same as one of the single primary colors.

2. The test device of claim 1, wherein each image with the single primary color has a same predetermined display period, the storage unit further stores the predetermined display period; the processing unit detects a duration of the currently detected color if the currently detected color is the same as one of the single primary colors; and
the processing unit determines whether the duration is equal to the predetermined display period, and determines that the read performance of the disc player is not satisfactory if the duration is not equal to the predetermined display period.

3. The test device of claim 2, wherein the processing unit determines that the read performance of the disc player is satisfactory if all detected colors are respectively and substantially the same as all single primary colors stored in the storage unit and the duration of each single detected color is equal to the predetermined display period.

4. The test device of claim 1, wherein the processing unit calculates an average R-value, an average G-value, and an average B-value of the pixels in the display unit to acquire the color of the test images.

5. The test device of claim 3, wherein the predetermined display period is 2 seconds.

6. The test device of claim 1, further comprising an indicating unit, wherein the processing unit controls the indicating unit to output an indication of abnormal read performance comprising reasons for abnormalities and the solutions.

7. The test device of claim 6, wherein the disc player comprises a motor driving IC, a motor, a decoder IC, an optical pickup unit, and a filter connected between the decoder IC and the optical pickup unit; the motor driving IC transmits a drive signal to the motor, the motor spins the test optical disc according to the drive signal; the decoder IC transmits a control signal to the optical pickup unit through the filter, the optical pickup unit reads the test optical disc in response to the control signal; the filter filters the control signal; the reasons for the abnormalities and the solutions comprises malfunctions of the optical pickup unit and the solutions of repairing or replacing the optical pickup unit; malfunctions of the filter and the solutions of repairing or replacing the filter; malfunctions of the motor driving IC and the solutions of repairing or replacing the motor driving IC; malfunctions of the decoder IC and the solutions of repairing or replacing the decoder IC; and damages to the optical pickup unit by ESD and the solutions of replacing the damaged optical pickup unit.

8. The test device of claim 6, further comprising an update module, wherein the update module is connected to the Internet for updating reasons for the abnormalities and the solutions.

9. A test method for testing read performance of a disc player, the test method comprising the steps of:
providing a test optical disc, the test optical disc stores data that is capable of being reproduced into a plurality of images each with a different single primary color;
providing a storage unit that stores the plurality of single primary colors;
enabling the disc player to read the test optical disc to generate video signals;
receiving the video signals from the disc player and displaying test images according to the video signals;
continuously detecting the color of the test images, determining whether the currently detected color is the same as one of the single primary colors stored in the storage unit; and
determining that the read performance of the disc player is not satisfactory if the currently detected color is not the same as one of the single primary colors stored in the storage unit.

10. The test method of claim 9, wherein each image with the single primary color has a same predetermined display period, the storage unit further stores the predetermined display period; the processing unit detects a duration of the currently detected color during which the currently detected color is the same as one of the single primary colors; the test method further comprising the steps of:
determining whether the duration is equal to the predetermined display period;
determining that the read performance of the disc player is not satisfactory if the duration is not equal to the predetermined display period.

11. The test method of claim 10, further comprising the steps of:
providing a timer, the times counts a predetermined time period from a point in time when the disc player begins to read the test optical disc;
determining whether the timer has timed out because the timed period has expired if the duration is equal to the predetermined display period; and
determining that the read performance of the disc player is satisfactory if the timer has timed out.

12. The test method of claim 11, further comprising the steps of: if the timer has not timed out, the process goes to the step of “determining whether the currently detected color is the same as one of the single primary colors”.

13. The test method of claim 9, wherein the processing unit calculates an average R-value, an average G-value, and an average B-value of the pixels in the display unit to acquire the color of the test images.

14. The test method of claim 10, wherein the predetermined display period is 2 seconds.

15. The test method of claim 9 or 10, further comprising the steps of:
outputting an indication of abnormal read performance comprising reasons for the abnormalities and the solutions.

16. The test method of claim 15, further comprising the steps of:
connecting to the Internet for updating reasons for the abnormalities and the solutions.

17. The test method of claim 15, wherein the disc player comprises a motor driving IC, a motor, a decoder IC, an optical pickup unit, and a filter connected between the decoder IC and the optical pickup unit; the motor driving IC transmits a drive signal to the motor, the motor spins the test optical disc according to the drive signal; the decoder IC transmits a control signal to the optical pickup unit through the filter, the optical pickup unit reads the test optical disc in response to the control signal; the filter filters the control signal; the reasons for the abnormalities and the solutions comprises malfunctions of the optical pickup unit and the solutions of repairing or replacing the optical pickup unit; malfunctions of the filter and the solutions of repairing or replacing the filter; malfunctions of the motor driving IC and the solutions of repairing or replacing the motor driving IC; malfunctions of the decoder IC and the solutions of repairing or replacing the decoder IC; damages to the optical pickup unit by ESD and the solutions of replacing the damaged optical pickup unit.

18. The test method of claim 9, wherein the plurality of single primary colors comprises white, red, blue, green, and black.
